(19) United States
(12) Patent Application Publication
(10) Pub. No.: US 2014/0379346 A1
(43) Pub. Date: Dec. 25, 2014

(54) VIDEO ANALYSIS BASED LANGUAGE MODEL ADAPTATION

(71) Applicant: Google Inc., Mountain View, CA (US)

(72) Inventors: Petar Aleksic, Jersey City, NJ (US); Xin Lei, Sunnyvale, CA (US)

(21) Appl. No.: 13/923,545

(22) Filed: Jun. 21, 2013

(51) Int. Cl. G10L 15/26; G10L 15/25

(52) U.S. Cl. CPC G10L 15/26; G10L 15/25
USPC 704/251

(57) ABSTRACT

Methods, systems, and apparatus, including computer programs encoded on a computer storage medium, for receiving audio data obtained by a microphone of a wearable computing device, wherein the audio data encodes a user utterance, receiving image data obtained by a camera of the wearable computing device, identifying one or more image features based on the image data, identifying one or more concepts based on the one or more image features, selecting one or more terms associated with a language model used by a speech recognizer to generate transcriptions, adjusting one or more probabilities associated with the language model that correspond to one or more of the selected terms based on the relevance of one or more of the selected terms to the one or more concepts, and obtaining a transcription of the user utterance using the speech recognizer.

### TECHNICAL FIELD

This document relates to speech recognition.

### BACKGROUND

Speech recognition systems attempt to identify one or more words or phrases from user input utterances. In some implementations, the identified words or phrases can be used to perform a particular task, for example, dial a phone number of a particular individual, generate a text message, or obtain information relating to a particular location or event. A user can submit an utterance using a computing device that includes a microphone. Sometimes, users can submit utterances that are ambiguous in that the speech can relate to more than one concept and/or entity. Additionally, in some instances, a user's manner of speaking or the meaning of a user's utterances can differ based on the environment of the user and/or based on an activity that the user is involved in.

### SUMMARY

A user can provide a spoken utterance to a computing device for various reasons, such as to initiate a search, request information, initiate communication, initiate the playing of media, or to request the computing device perform other operations. In some instances, the provided utterance is ambiguous or can be otherwise misinterpreted by a speech recognizer. For example, a user can input a phrase that contains the term, “beach,” and, in the absence of additional information, the term, “beach” may be interpreted by a computing environment as the term, “beech.” As a result of incorrectly identifying a phrase in a user utterance, the computing device may perform operations that are not intended by the user. For example, the computing device may access and provide information to the user relating to furniture made from beech wood, or may provide driving directions to a park that is known to contain numerous beech trees, instead of providing information relating to nearby beaches or driving directions to a particular beach.

To obtain a transcription of a user utterance that matches the user's intent, image and/or other data can be obtained from the environment of the user. Using the image data obtained from the environment of the user, the computing environment can identify one or more concepts corresponding to the image data. A speech recognizer associated with the computing environment can obtain a transcription of the user utterance that is based on the one or more concepts.

Innovative aspects of the subject matter described in this specification may be embodied in methods that include the actions of receiving audio data obtained by a microphone of a wearable computing device, wherein the audio data encodes a user utterance, receiving image data obtained by a camera of the wearable computing device, identifying one or more image features based on the image data, identifying one or more concepts based on the one or more image features, selecting one or more terms associated with a language model used by a speech recognizer to generate transcriptions, adjusting one or more probabilities associated with the language model that correspond to one or more of the selected terms based on the relevance of one or more of the selected terms to the one or more concepts, and obtaining a transcription of the user utterance using the speech recognizer.

Other embodiments of these aspects include corresponding systems, apparatus, and computer programs, configured to perform the actions of the methods, encoded on computer storage devices.

These and other embodiments may each optionally include one or more of the following features. For instance, identifying one or more image features based on the image data further comprises obtaining a result of performing at least an optical character recognition process on the image data, and identifying one or more image features based on the result; identifying one or more image features based on the image data further comprises obtaining a result of performing a feature matching process on the image data, and identifying one or more image features based on the result; and identifying one or more image features based on the image data further comprises obtaining a result of performing a shape matching process on the image data, and identifying one or more image features based on the result.

Other innovative aspects of the subject matter described in this specification may be embodied in a system or computer readable storage device storing instructions that cause operations to be performed that include receiving audio data encoding a user utterance, receiving image data, identifying one or more concepts based on the image data, influencing a speech recognizer based at least on the one or more concepts, and obtaining a transcription of the user utterance using the speech recognizer.

Other embodiments of these aspects include corresponding systems, apparatus, and computer programs, configured to perform the actions of the methods, encoded on computer storage devices.

These and other embodiments may each optionally include one or more of the following features. For instance, identifying one or more concepts based on the image data further comprises obtaining a result of performing at least an optical character recognition process on the image data; and identifying one or more concepts based on the result; identifying one or more concepts based on the image data further comprises obtaining a result of performing a feature recognition process on the image data, and identifying one or more concepts based on the result; identifying one or more concepts based on the image data further comprises obtaining a result of performing a shape matching process on the image data, and identifying one or more concepts based on the result; influencing a speech recognizer based at least on the one or more concepts further comprises selecting one or more terms associated with a language model, and adjusting one or more probabilities associated with the language model that correspond to one or more of the selected terms based on the relevance of one or more of the selected terms to one or more concepts, wherein the speech recognizer uses the language model comprising the adjusted probabilities to generate the transcription; influencing the speech recognizer based at least on the one or more concepts further comprises selecting a language model associated with one or more of the concepts, wherein the speech recognizer uses the selected language model to generate the transcription; influencing the speech recognizer based at least on the one or more concepts further comprises selecting a language model associated with one or more of the concepts, and interpolating the language model associated with one or more of the concepts with a general language model, wherein the speech recognizer uses the interpolated language model to generate the transcription; and the audio data encoding the user utterance is obtained by a microphone of a wearable computing device, and the image data is obtained by a camera of the wearable computing device.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is an example of a system that can be used for performing video analysis based language model adaptation.

FIG. 2 is a schematic diagram of an example system for performing video analysis based language model adaptation.

FIG. 3 a flowchart of an example method for performing video analysis based language model adaptation.

Like reference symbols in the various drawings indicate like elements.

### DETAILED DESCRIPTION

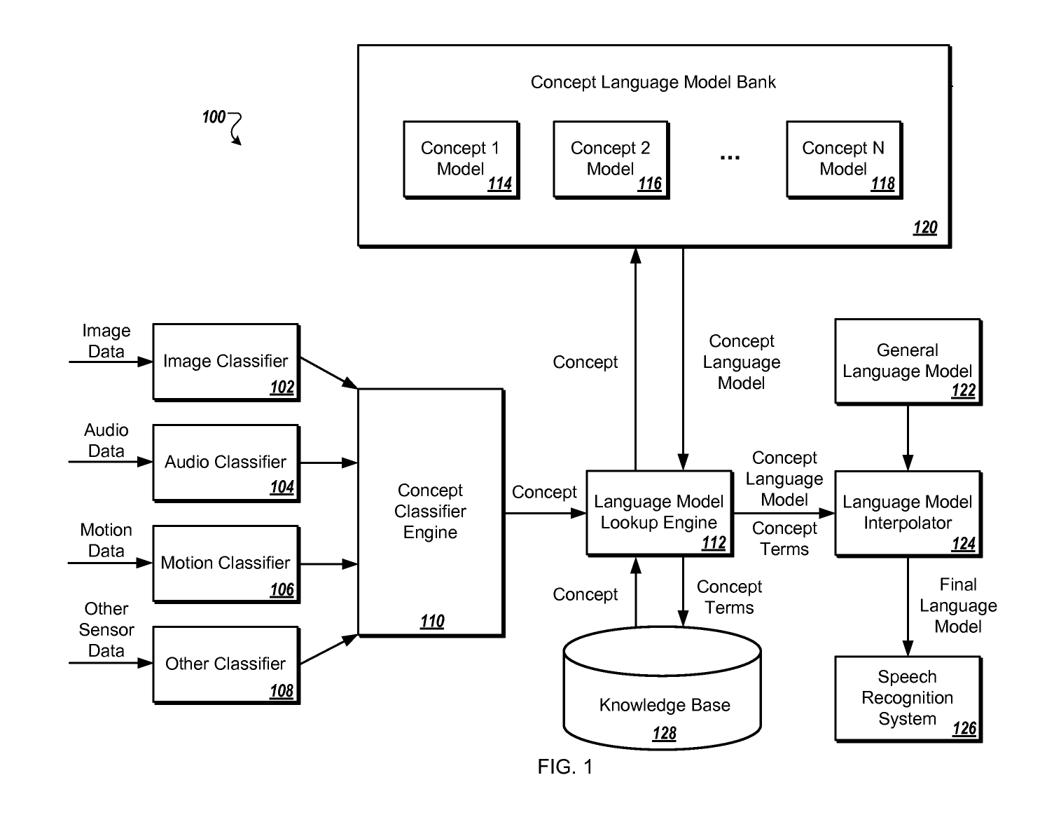

FIG. 1 depicts a system 100 for performing video analysis based language model adaptation. In general, the system 100 can adapt a language model used to perform speech recognition based on image and/or other data obtained from the environment of a user. For example, the system 100 can use image data from the environment of a user that is obtained by a camera associated with a user's computing device to adapt a language model used when performing speech recognition. A more accurate transcription of a user utterance can be obtained based on using the adapted language model to perform speech recognition on the utterance. As used in this specification, speech recognition refers to the translation of spoken utterances into text, and image data can include data corresponding to one or more still images, frames of video content, segments of video content, video content streams, etc.

The system 100 includes classifiers 102, 104, 106, 108, concept classifier engine 110, language model lookup engine 112, concept language model bank 120, language model interpolator 124, and speech recognition system 126. Classifiers can include one or more image classifiers 102, audio classifiers 104, motion classifiers 106, or other classifiers 108. The concept language model bank 120 can be associated with one or more concept-specific language models 114, 116, 118. In some instances, the language model interpolator 124 can access a general language model 122.

The classifiers 102, 104, 106, 108 can receive image and/or other data identifying the environment of the user. The classifiers 102, 104, 106, 108 can analyze the received image and/or other data, and can transmit information classifying the received data to the concept classifier engine 110.

Based on receiving the information classifying the image and/or other data, the concept classification engine 110 can identify one or more concepts. As used in this specification, a concept can include a particular type of location associated with a user that has spoken an utterance at a computing device, e.g., a city location, a beach location, an office location, a store location, a home location, etc., can identify a particular activity that the user is involved in, e.g., whether a user is driving, running, shopping, attending a concert, working at a computer, etc., can include particular media that is in the environment of the user, e.g., a particular television show, movie, music selection, etc., or can include any other identifying information that can be used to determine the context of the utterance spoken by the user.

The concept classification engine 110 identifies the one or more concepts and transmits data identifying the one or more concepts to the language model lookup engine 112. Based on receiving the data identifying the one or more concepts, the language model lookup engine 112 communicates with the concept language model bank 120 and receives one or more concept-specific language models 114, 116, 118 based on the identified one or more concepts.

The language model lookup engine 112 transmits data relating to the one or more identified concept-specific language models 114, 116, 118 to the language model interpolator 124. In some implementations, the language model interpolator 124 can access a general language model 122, and can interpolate the general language model 122 with the one or more identified concept-specific language models 114, 116, 118. The speech recognition system 126 can use the interpolated language model to obtain a transcription of the spoken utterance input by the user.

Data encoding a spoken user utterance and image and/or other data identifying the environment of the user can be obtained by a computing device associated with the user. For example, a user can say a phrase at a computing device that includes the term, “beach,” and a transcription of the phrase can be obtained based on image and/or other data obtained from the environment of the user.

In some instances, audio data can be received that encodes an utterance input by the user, for example, data that encodes a phrase input by a user and containing the term, “beach.” In some instances, the audio data can be received at a computing device associated with the user, such as by using a microphone associated with the computing device. In some instances, a computing device associated with the user is a mobile computing device, such as a mobile phone, personal digital assistant (PDA), smart phone, music player, e-book reader, tablet computer, laptop computer, or other portable device.

In addition to audio data encoding the user input utterance, image and/or other data can be received identifying the environment of the user. Image and/or other data can include, for example, video data from the environment of the user, audio data from the environment of the user, motion data from the environment of the user, temperature data from the environment of the user, ambient light data from the environment of the user, moisture and/or humidity data from the environment of the user, and/or other data from the environment of the user that is obtainable by one or more sensors associated with the user's computing device.

In some instances, it may be necessary to avoid using image and/or other data received that identifies the environment of the user, where the image and/or other data includes video, image, audio, or other data that the user may want to keep private or otherwise would prefer not to have recorded and/or analyzed. For example, video, image, audio, or other data can include a private conversation, or some other type of video, image, audio, or other data that the user does not wish to have captured. Video, image, audio, or other data that the user may want to keep private may even include data that may be considered innocuous, such as a song playing in the environment of the user, but that may divulge information about the user that the user would prefer not to have made available to a third party.

Because of the need to ensure that the user is comfortable with having video, image, audio, or other data from the environment of the user processed in the event that the data includes content or information that the user does not wish to have recorded and/or analyzed, implementations should provide the user with a chance to affirmatively consent to the receipt of the data before receiving and/or analyzing the data. Therefore, the user can be required to take an action to specifically indicate that he or she is willing to allow the implementations of the system to capture video, audio, or other data before the implementations are permitted to start obtaining such information.

For example, a computing device associated with a user can prompt the user at an interface of the computing device with a dialog box or other graphical user interface element to alert the user with a message that makes the user aware that the computing device is about to monitor background video, image, audio, or other information, e.g., motion of the user's computing device. For example, a message may state, “Please authorize use of captured audio and video. Please note that information from audio and video may be shared with third parties.” Thus, in order to ensure that the video, image, audio, or other data is gathered exclusively from consenting users, implementations can notify the user that gathering the audio and video data is about to commence, and furthermore that the user should be aware that information corresponding to or associated with the audio and video data that is accumulated can be shared in order to make determinations based on the audio and video data.

After the user has been alerted to these issues, and has affirmatively agreed that he or she is comfortable with the obtaining of the video, image audio, or other data, the video, image audio, or other data can be obtained, for example, by using a camera, microphone, gyroscope, global positioning system (GPS), ambient light sensor, temperature sensor, or other sensor associated with the user's computing device. Furthermore, certain implementations can prompt the user to again ensure that the user is comfortable with having video, image, audio, or other data gathered from the user's computing device if the system has remained idle for a period of time. That is, the idle time may indicate that a new session has begun, and prompting the user again can ensure that the user is aware of privacy issues related to the system obtaining video, image, audio, or other data from the user's computing device.

For situations in which the systems discussed here collect personal information about users, or may make use of personal information about users, the users can be provided with an opportunity to control whether programs or features collect personal information, e.g., information about a user's social network, social actions or activities, profession, a user's preferences, or a user's current location, or to control whether and/or how to receive content from the content server that can be more relevant to the user. In addition, certain data can be anonymized in one or more ways before it is stored or used, so that personally identified information is removed.

For example, a user's identity can be anonymized so that no personally identifiable information can be determined for the user, or a user's geographic location can be generalized, where location information is obtained, such as to a city, ZIP code, or state level, so that a particular location of a user cannot be determined. Thus, the user can have control over how information is collected about him or her and used by a content server.

Based on receiving image and/or other data identifying the environment of the user, the image and/or other data can be transmitted and received at one or more classifiers 102, 104, 106, 108. For example, image data from the environment of the user can be received at a image classifier 102, audio data from the environment of the user can be received at an audio classifier 104, motion data from the environment of the user can be received at a motion classifier 106, and other data obtained from the environment of the user can be received at one or more other classifiers 108.

In some instances, the image and/or other data can be received by the classifiers 102, 104, 106, 108 over one or more networks, such as one or more local area networks (LAN), or wide area networks (WAN), such as the internet. In some instances, the one or more classifiers 102, 104, 106, 108 can be included in a computing device associated with the user, and the one or more classifiers 102, 104, 106, 108 can receive the image and/or other data locally from the user's computing device.

Based on receiving image and/or other data, the one or more classifiers 102, 104, 106, 108 can classify the image and/or other data. For example, the image classifier 102 can classify the image data as pertaining to a type of location associated with the user, e.g., a beach, city, house, store, or residence location type. In some embodiments, the image classifier can classify the image data based on performing optical character recognition, feature matching, shape matching, or another image processing technique.

In some instances, image data can be classified based on performing optical character recognition on the image data. For example, the image classifier 102 can perform optical character recognition on one or more frames of video data and can classify the video data based on performing the optical character recognition. For example, the image classifier 102 can perform optical character recognition on one or more frames of the video data and can identify the presence of the terms, “Newport Beach,” from one or more frames of the video data. Based on identifying the presence of the terms “Newport Beach” from one or more frames of the video data, the image classifier 102 can classify the video data as pertaining to a location type corresponding to a beach setting.

In some instances, image data can be classified based on performing feature matching on the image data. The image classifier 102 can perform feature matching on one or more frames of video data and can classify the video data based on performing the feature matching. In some instances, performing feature matching can include performing edge detection, identifying corners or points of interest, identifying blobs or regions of interest, and/or identifying ridges in one or more frames of video data or one or more images, and matching the identified edges, corners, blobs, or ridges to one or more known features. For example, the image classifier 102 can perform feature matching on one or more frames of the video data and can identify the presence of a curved edge corresponding to a horizon, i.e., the image classifier 102 can identify a smooth horizon line such as that seen separating earth and sky when looking at a body of water. Based on identifying the curved edge as a horizon line, the image classifier 102 can classify the video data as pertaining to a location type corresponding to a beach setting.

In some instances, image data can be classified based on performing shape matching on the image data. For example, the image classifier 102 can perform shape matching on one or more frames of video data and can classify the video data based on performing the shape matching. In some instances, performing shape matching can include identifying a shape as matching one of a predetermined set of potential shapes. For example, the image classifier 102 can perform shape matching on one or more frames of video data and can identify the presence of a large circle shape and can further identify the presence of a palm tree shape. Based on identifying the large circle shape as corresponding to the sun, and based on identifying the palm tree shape as corresponding to a palm tree, the image classifier 102 can classify the video data as pertaining to a location type corresponding to a tropical setting, e.g., an outdoor beach setting.

In some embodiments, an audio classifier 104 can classify audio data received from the environment of the user. For example, the audio classifier 104 can classify the audio data as pertaining to a type of location associated with the user, e.g., a beach, city, house, store, or residence location type. In some embodiments, the audio classifier 104 can classify the received audio data by performing audio matching on the received audio data.

For example, in some instances, audio data can be classified based on performing acoustic fingerprint matching on the audio data. The received audio data can be fingerprinted and the acoustic fingerprints can be compared to acoustic fingerprints associated with various location types, media types or specific media content, or other environmental features. For example, audio data received by the audio classifier 104 can be fingerprinted, and the acoustic fingerprints from the audio data can be identified as matching acoustic fingerprints for the sound of waves crashing on a beach. Based on determining that the audio data matches the sounds of waves crashing on a beach, the audio classifier can classify the audio data as corresponding to a beach setting. In another example, audio data received by the audio classifier 104 can be fingerprinted, and the acoustic fingerprints from the audio data can be identified as matching a particular piece of content, for example, a particular song, and the audio classifier can classify the audio data as corresponding to a music venue setting, as a setting inside of a car where music would be played, or can classify the audio as corresponding to another setting.

In some embodiments, a motion classifier 106 can classify motion data received from the environment of the user. For example, the motion classifier 106 can classify the motion data as pertaining to a type of location associated with the user, e.g., a beach, city, house, store, or residence location type, or can classify the motion data as pertaining to a type of activity that the user is involved in, e.g., running, driving, walking, or another activity. In some embodiments, the motion classifier 106 can classify the received motion data by performing motion data matching on the received motion data.

For example, in some instances, motion data can be classified based on matching the motion data against one or more motion data signatures. The received motion data can be compared against one or more motion signatures corresponding to various activities, for example, motion signatures corresponding to activities of running, driving, walking, or other activities. For example, motion data that indicates that the user is rapidly moving up and down can be identified as corresponding to the user running. Based on determining that the motion data matches the motion signature corresponding to a user running, the motion classifier can classify the motion data as corresponding to an outdoor setting, based on motion classifier 106 being programmed to determine that running motion correlates to an outdoor setting.

In some embodiments, one or more other classifiers 108 can classify data received from the environment of the user. For example, one or more other classifiers 108 can classify data received from the environment of the user that indicates temperature, ambient light brightness, humidity and/or moisture, or other data, and the one or more other classifiers 108 can classify the data. For example, ambient light data above a certain threshold can be classified as pertaining to an outdoor setting, and/or temperature data outside of a certain indoor temperature range can cause the temperature data to be classified as pertaining to an outdoor setting.

To perform classification, the classifiers 102, 104, 106, 108 can be associated with one or more databases storing data relating to image features, e.g., image shapes, characters, or features, audio fingerprints, motion characteristics, temperature ranges, ambient light ranges, humidity and/or moisture ranges, and their corresponding classifications. Additionally or alternatively, the one or more classifiers 102, 104, 106, 108 can be associated with means for performing, for example, optical character recognition, audio fingerprinting, feature matching, shape matching, motion data matching, or other analysis on the image and/or other data received at the one or more classifiers 102, 104, 106, 108.

Data identifying classifications for image and/or other data is transmitted and received by the concept classifier engine 110. In some instances, the data identifying classifications for image and/or other data can be received by the concept classifier engine 110 over one or more networks, or can be received locally from the one or more classifiers 102, 104, 106, 108 associated with the system 100. Based on the data identifying classifications for the image and/or other data, the concept classifier engine can identify one or more concepts associated with the image and/or other data.

In some instances, the concept classifier engine 110 can identify one or more concepts associated with the image and/or other data based on the data identifying one or more classifications for image and/or other data received from the classifiers 102, 104, 106, 108. For example, classifications for image data received from the image classifier 102 can indicate that the image data received from the environment of the user pertains to a beach setting, and, based on the classification, the concept classifier engine 110 can identify a beach or ocean concept.

In some instances, the concept classifier engine 110 can receive one or more different classifications from the one or more classifiers 102, 104, 106, 108, and the concept classifier engine 110 can identify one or more concepts based on the received classifications. For example, the concept classifier engine 110 can receive classifications from the image classifier 102 identifying a beach setting, classifications from the audio classifier 104 identifying a car setting, classifications from a motion classifier 106 identifying a driving setting, and classifications from other classifiers 108 indicating an indoor setting. Based on the received classifications, the concept classifier engine 110 can identify concepts relating to a beach or ocean concept as well as a car or driving concept.

In some implementations, the concept classifier engine can integrate or combine one or more concepts to identify a compound concept. For example, based on identifying a beach or ocean concept as well as a car or driving concept, the concept classifier engine 110 can identify a compound concept relating to driving near a beach.

In some instances, the concept classifier engine 110 identifies one or more concepts based on a probability that a particular concept is related to the received classifications. For example, the concept classifier engine 110 can assign a confidence score to each of the identified classifications indicating a likelihood that the particular classification is relevant to the received image and/or audio data, and the concept classifier engine 110 can identify one or more concepts based on the confidence scores.

In some instances, identifying one or more concepts based on the confidence scores can include identifying concepts related to classifications that have a confidence score above a certain threshold, or can include identifying concepts related to the one or more classifications with the highest confidence score. In some instances, a lower confidence score can indicate a greater likelihood that the particular classification is relevant to the received image and/or audio data, and the concept classifier engine 110 can identify one or more concepts based on the classifications having confidence scores below a certain threshold or based on the one or more classifications having the lowest confidence scores.

Based on identifying one or more concepts, the concept classifier engine 110 transmits data identifying the one or more concepts to the language model lookup engine 112. In some instances, the language model lookup engine 112 receives data identifying one or more concepts over one or more networks, wired connections, or wireless connections.

Based on the one or more identified concepts, the language model lookup engine 112 can access one or more concept-specific language models 114, 116, 118. For example, the language model lookup engine 112 can access a concept language model bank 120 and can identify one or more concept-specific language models 114, 116, 118 associated with the concept language model bank 120. In some implementations, the language model lookup engine 112 can access one or more of the concept-specific language models 114, 116, 118 by communicating information identifying the one or more identified concepts to the concept language model bank 120 and receiving one or more relevant concept-specific language models 114, 116, 118 based on the one or more identified concepts.

In some instances, the one or more concept-specific language models 114, 116, 118 can be language models that correspond to one or more concepts. For example, the concept classifier engine 110 may be capable of identifying one or more of a finite (N) number of concepts as relating to image and/or other data, and the concept language model bank 120 may be associated with the finite (N) number of concept-specific language models corresponding to the concepts.

In some instances, identifying one or more concept-specific language models 114, 116, 118 can include identifying one or more language models that pertain to the particular concepts identified by the concept classifier engine 110. For example, based on the concept classifier engine 110 identifying concepts relating to a beach or ocean concept and a car or driving concept, the language model lookup engine 112 can access a language model associated with a beach or ocean concept as well as a language model associated with a car or driving concept. In other instances, the language model lookup engine 112 can identify only one concept-specific language model 114, 116, 118, such as a single language model relating to one of a beach or ocean concept or a car or driving concept. In some instances, the concept language model bank 120 can maintain or generate one or more compound language models, such as a language model pertaining to driving near a beach.

Based on accessing one or more concept-specific language models, the language model lookup engine 112 can provide the one or more concept-specific language models to the language model interpolator 124. The language model interpolator 124 can receive the one or more concept-specific language models from the language model lookup engine 112 over one or more networks, or through one or more wired or wireless connections.

In some embodiments, the language model interpolator 124 can receive the one or more concept-specific language models received from the language model lookup engine 110, and the language model interpolator 124 can interpolate the one or more concept-specific language models to generate a final language model. For example, the language model interpolator 124, based on receiving a concept-specific language model relating to a beach or ocean concept and a concept-specific language model relating to a car or driving concept, can interpolate the two concept-specific language models and generate a compound language model that is a final language model. In some instances, if only one concept-specific language model is received at the language model interpolator 124, a final language model can be the same as the concept-specific language model, i.e., no interpolation of the concept-specific language model with another language model is performed and the concept-specific language model is identified as the final language model.

In some embodiments, the language model interpolator 124 can access a general language model 122 and can interpolate the one or more concept-specific language models with the general language model 122. In some instances, the language model interpolator 124 can access the general language model 122 over one or more networks, can access the general language model 122 over a wired or wireless connection, or can access the general language model 122 locally, for example, based on accessing the general language model 122 at a memory or other storage component associated with the language model interpolator 124.

In some instances, the general language model 122 is a language model that is nonspecific to the context of a user utterance, i.e., is a generic language model used to perform speech recognition on audio data that contains spoken language and that is not specific to any particular location, activity, environment, etc. The language model interpolator 124 can interpolate the general language model 122 with the one or more concept-specific language models to obtain a final language model that can be used by a speech recognition system 126 to perform speech recognition on user utterances. In some instances, obtaining a final language model that is an interpolation of a general language model 122 and one or more concept-specific language models can enable a speech recognition system 126 to perform speech recognition on user utterances that results in more accurate transcriptions of the user utterances, based on the final language model enabling contextual speech recognition.

In some embodiments, the language model interpolator 124 can interpolate the one or more language models, e.g., one or more concept-specific language models, a general language model 122, etc., based on a weighting of the importance of each language model. For example, a general language model 122 and each of one or more concept-specific language models can be assigned particular weights based on their relevance, and the language model interpolator 124 can interpolate the language models based on the weights. In some instances, weights assigned to the one or more concept-specific language models can be based on confidence scores assigned to the one or more concept-specific language models. For example, a concept-specific language model relating to a beach or ocean concept can be assigned a first weight, a concept-specific language model relating to a car or driving concept can be assigned a second weight, a general language model 122 can be assigned a third weight, and the language model interpolator 124 can interpolate the three language models based on the weights assigned to the language models.

In some embodiments, the language model interpolator 124 can generate a final language model by adjusting probabilities associated with one or more terms of a language model based on one or more identified concepts, and the language model having the adjusted probabilities can be used to perform speech recognition. In some embodiments, adjusting probabilities associated with the terms of a language model can be performed in addition or alternatively to performing interpolation of one or more concept-specific or general language models.

For example, the concept classifier engine 110 can identify a beach or ocean concept based on image and/or other data, and based on the concept relating to a beach or ocean being identified, probabilities associated with certain terms of a language model can be adjusted. For example, term probabilities associated with a general language model 122 that includes the terms “beach,” “beech,” “sun,” and “son,” can be adjusted such that the probabilities associated with the terms “beach” and “sun” are increased and probabilities associated with the terms “beech” and “son” are decreased. In other instances, different language models or different terms associated with language models can be adjusted, based on the identified one or more concepts. In some instances, some words may be removed from a language model based on the one or more concepts, or can otherwise be omitted, e.g., by adjusting the probability associated with a term to zero.

In some implementations, alternatively or in addition to accessing the concept language model bank 120, the language model lookup engine 112 can access a knowledge base 128. For example, the language model lookup engine 112 can access the knowledge base 128 and can identify one or more concept-specific terms. In some implementations, the language model lookup engine 112 can access one the knowledge base 128 by communicating information identifying the one or more identified concepts to the knowledge base 128 and receiving one or more concept-specific terms based on the one or more identified concepts.

In some instances, the concept-specific terms maintained at the knowledge base 128 can include one or more terms that pertain to the particular concepts identified by the concept classifier engine 110. For example, based on the concept classifier engine 110 identifying concepts relating to a beach or ocean concept and a car or driving concept, the language model lookup engine 112 can access the knowledge base 128 and receive terms related to a beach or ocean concept as well as terms related to a car or driving concept. In some instances, the knowledge base 128 can maintain or identify one or more terms that are associated with one or more compound concepts, such as one or more terms associated with a compound concept pertaining to driving near a beach.

Based on accessing one or more concept-specific terms, the language model lookup engine 112 can provide the one or more concept-specific terms to the language model interpolator 124. The language model interpolator 124 can receive the one or more concept-specific terms from the language model lookup engine 112 over one or more networks, or through one or more wired or wireless connections.

In some embodiments, the language model interpolator 124 can access a general language model 122 and can adjust the general language model 122 based on the one or more concept-specific terms. In some instances, the language model interpolator 124 can access the general language model 122 over one or more networks, can access the general language model 122 over a wired or wireless connection, or can access the generally language model 122 locally, for example, based on accessing the general language model 122 at a memory or other storage component associated with the language model interpolator 124.

In some implementations, the language model interpolator 124 can adjust the general language model 122 based on the one or more concept-specific terms by adding the concept-specific terms to the general language model 122. For example, the general language model 122 may contain a general lexicon, and the language model interpolator 124 can adjust the general language model by adding the concept-specific terms to the lexicon of the general language model 122.

In other implementations, the language model interpolator 124 can adjust the general language model 122 based on the one or more concept-specific terms by adjusting probabilities associated with the terms of the of the general language model 122. For example, the general language model 122 may contain a lexicon, the terms of the lexicon may be associated with probabilities indicating the likelihood of each term being used by a user, and the language model interpolator 124 can adjust probabilities associated with terms of the general language model 122 based on the concept-specific terms received from the language model lookup engine 112. For example, based on the term “beach” being included in the concept-specific terms received at the language model interpolator 124, the language model interpolator 124 can increase a probability associated with the term “beach” included in the general language model 122, and/or can decrease a probability associated with the term “beech” included in the language model 122. The general language model 122 featuring adjustments based on the concept-specific terms received at the language model interpolator 124 can be used as a final language model to perform speech recognition.

Based on generating a final language model, the language model interpolator 124 can provide the final language model to a speech recognition system 126. The speech recognition system 126 can receive the final language model from the language model interpolator 124, for example, by receiving the final language model over one or more networks, one or more wired or wireless connections, or locally through an association of the language model interpolator 124 and the speech recognition system 126.

Based on receiving the final language model, the speech recognition system 126 can perform speech recognition on user utterances using the final language model. For example, the speech recognition system 126 can use the final language model that is an interpolation of the concept-specific language model relating to a beach or ocean concept, the concept-specific language model relating to a car or driving concept, and a general language model 122 to obtain a transcription of a user utterance. For instance, the speech recognition system 126 can use the final language model to generate a transcription of a phrase input by a user that includes the term, “beach,” and can correctly identify the phrase as including the term, “beach,” as opposed to incorrectly identifying the phrase as including the term, “beech.” The speech recognition system 126 can obtain a correct transcription of the phrase that includes the term, “beach,” based on the final language model featuring a preference for the term, “beach,” over the term, “beech,” based on the final language model incorporating a language model that is specific to a beach or ocean concept.

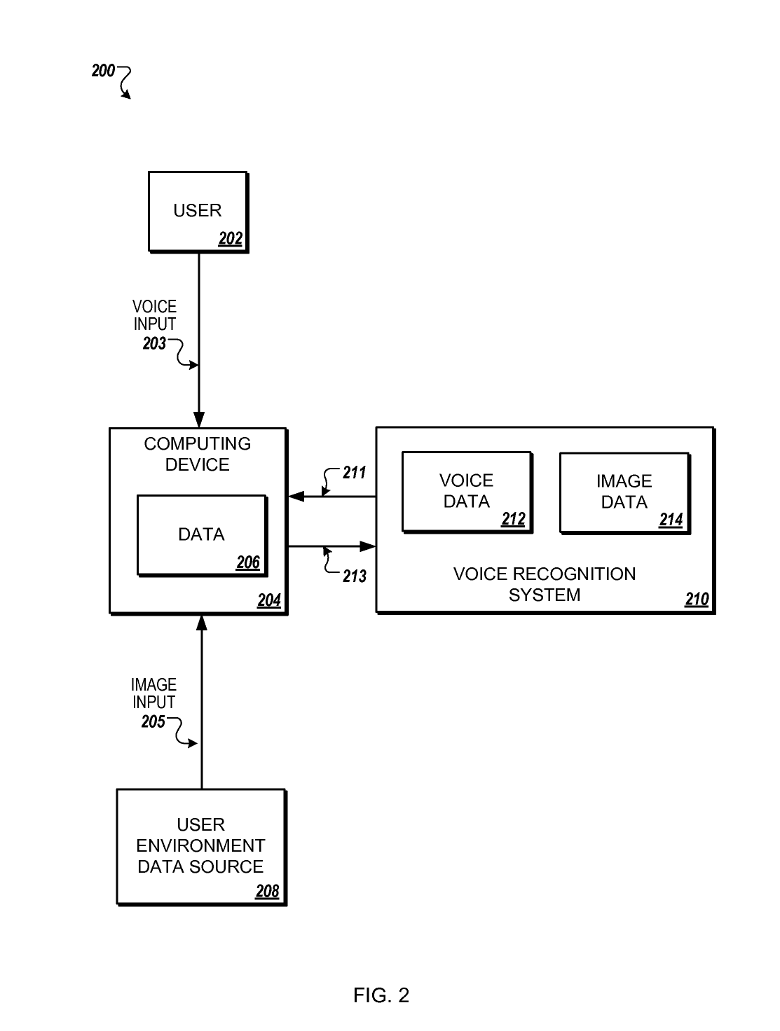

FIG. 2 is a schematic diagram of an example system 200 for performing video analysis based language model adaptation. Per FIG. 2, a user 202 provides voice input 203, such as a spoken utterance, to be recognized using a voice recognition system 210. The user 202 may do so for a variety of reasons, but in general, the user 202 may want to perform a task using one or more computing devices 204. For example, the user 202 may wish to have the computing device 204 “find the nearest gas station,” or may ask the question, “what is the water like today?” in reference to a beach that they are visiting.

In general, when the user 202 provides the voice input 203, the computing device 204 can obtain information in addition to the voice input 203. For example, as shown in FIG. 2, the computing device 204 can receive image input 205 from user environment data source 208. For example, if the user 202 is driving in their car, the user environment data source 208 can obtain image data from the environment of the user 202 and can provide the image data as image input 205 to the computing device 204. In such an instance, image data from the environment of the user 202 can include video data containing images of the inside of the car that the user 202 is driving, can include video data containing images of the road that the user 202 is driving on, or can include other image and/or video data from the environment of the user 202 while the user 202 is driving.

In some instances, the user environment data source 208 can include any number of sensors or detectors that are capable of obtaining data from the environment of the user 202 and providing data to the computing device 204. For example, the user environment data source 208 can include one or more cameras, video recorders, microphones, motion sensors, geographical location devices, e.g., GPS devices, temperature sensors, ambient light sensors, moisture and/or humidity sensors, etc. In such instances, data provided from the user environment data source 208 to the computing device 204 can include, alternatively or in addition to image and/or video data, audio data from the environment of the user 202, motion data from the environment of the user 202 indicating the user's movements, a geographical location of the user 202, temperatures of the environment of the user 202, ambient brightness of the environment of the user 202, humidity and/or moisture levels in the environment of the user 202, etc.

In some implementations, the user environment data source 208 is included in the computing device 204, for example, by being integrated with the computing device 204, and is able to communicate with the computing device 204 over one or more local connections, e.g., one or more wired connections. In some implementations, the user environment data source 208 can be external to the computing device 204 and can be able to communicate with the computing device 204 over one or more wired or wireless connections, or over one or more local area networks (LAN) or wide area networks (WAN), such as the Internet.

In some implementations, a combination of voice input 203 and image input 205 can be received by the computing device 204 and combined as data 206. For example, the voice input 203 and the image input 205 can be received during a substantially similar time interval and combined to form data 206 that includes video data featuring the spoken utterance of the user 202. In another example, data from the environment of the user 202 can include ambient audio data from the environment of the user 202, and the data 206 can include a combination of the voice input 203 audio data and the ambient audio data, for example, as a single audio stream.

In practice, data obtained by the user environment data source 208 from the environment of the user 202 can be obtained prior to, concurrently with, or after the receiving of the voice input 203 by the computing device 204. In some instances, the user environment data source 208 can continuously stream data to the computing device 204, and the data 206 can be a combination of relevant data received from the user environment data source 208 and the voice input 203. In such an instance, the computing device 204 may determine that a portion of the data received from the user environment data source 208 is relevant, and can include the relevant portion of the data received from the user environment data source 208 in the data 206. In some instances, the data 206 can be a combination of the voice input 203 and the data received from the user environment data source 208, e.g., in a single data packet that includes both the data associated with the voice input 203 and the data received from the user environment data source 208, or the data 206 can contain separate data packets relating to the data associated with the voice input 203 and the data received from the user environment data source 208.

A voice recognition system 210 can receive both the voice input 203 and the image input 205 and use a combination of each to recognize concepts associated with the voice input 203. In some implementations, the voice recognition system 210 can receive the data 206 using communications channel 213 and can detect voice data 212 and image data 214 contained in the data 206 corresponding to the voice input 203 and the image input 205, respectively. Based on the detection, the voice recognition system 210 can separate the data 206 received from the computing device 204 to obtain the voice data 212 and the image data 214. In other implementations, the voice recognition system 210 can receive the voice data 212 and the image data 214 from the computing device 204, where the computing device 204 has isolated the voice data 212 and the image data 214. In some instances, the channel 213 can include one or more wired or wireless data channels, or one or more network data channels, such as one or more local area network (LAN) data channels or wide area network (WAN) data channels.

In some implementations, based on the data provided to the computing device 204 by the user environment data source 208 including data alternatively or in addition to image data from the environment of the user 202, the image data 214 can comprise different or additional data. For example, based on the user environment data source 208 providing ambient audio data from the environment of the user 202, motion data from the environment of the user 202, geographical location data relating to the user 202, temperature data from the environment of the user 202, ambient light data from the environment of the user 202, moisture and/or humidity data from the environment of the user 202, etc., the image data 214 can include this data in addition or alternatively to image and/or video data obtained from the environment of the user 202.

The voice recognition system 210 utilizes the voice data 212 and the image data 214 to determine one or more concepts associated with the voice data 212 and to obtain a transcription of the voice data 212. In some implementations, image data 214 can be used to identify one or more concepts associated with the voice data 212, and the one or more identified concepts can be used in obtaining a transcription of the voice data 212 associated with the voice input 203.

For example, if the image input 205 includes image features associated with a car setting, e.g., image features corresponding to a road that a user 202 is driving on or a steering wheel in front of the user 202, the voice recognition system 210 may determine that the user 202 is driving and may identify a concept associated with a car or driving setting to be used in determining a transcription of the voice input 203. For example, the voice recognition system 210 may use the identified concept associated with a car or driving setting to determine a transcription of a voice input 203 that includes the phrase, “find the nearest gas station.” In another example, the voice recognition system 210 can determine that the image input 205 includes image features associated with a beach setting, e.g., image features corresponding to a horizon, a palm tree, or a lifeguard stand, can identify a concept associated with a beach or ocean setting, and can use the concept in determining a transcription of the voice input 203 that includes the phrase, “what is the water like today?”

In some implementations, the voice recognition system 210 can use other data that comprises the image data 214 to determine one or more concepts and to use the one or more concepts to obtain a transcription of a voice input 203. For example, the voice recognition system 210 can identify one or more concepts based on image data 214 that includes data received from the user environment data source 208, such as image and/or video data from the environment of the user 202, ambient audio data from the environment of the user 202, motion data from the environment of the user 202, geographical location data relating to the user 202, temperature data from the environment of the user 202, ambient light data from the environment of the user 202, moisture or humidity data from the environment of the user 202, etc.

In some implementations, one or more concepts stored in one or more data repositories can be included in the voice recognition system 210. In some implementations, the voice recognition system 210 can communicate with a search system that identifies the one or more related concepts based on one or more query terms associated with aspects of the voice input 203 and/or the image input 205 or other data received from the user environment data source 208. In some implementations, the recognition system 210 can be an application or service being executed by the computing device 204, or can be an application or service that is accessible by the computing device 204, for example, over one or more local area networks (LAN) or wide area networks (WAN), such as the Internet. In some implementations, the voice recognition system 210 can be an application or service being executed by a server system in communication with the computing device 204.

In some implementations, the voice recognition system 210 can use the image data 214 and other data associated with the image data 214 that is received from the user environment data source 208 to identify one or more concepts and to influence or generate a language model used to generate transcriptions based on the one or more concepts. For example, based on the voice recognition system 210 identifying one or more concepts associated with the image data 214, the voice recognition system 210 can identify one or more language models associated with the one or more concepts and can use the one or more language models to generate a transcription of the voice input 203. In some instances, the voice recognition system 210 can generate a single language model for use in generating a transcription of the voice input 203 by interpolating one or more language models associated with the one or more concepts. In some implementations, the voice recognition system 210 can influence a general language model used to generate transcriptions of voice inputs 203 to produce transcriptions that are relevant to the one or more identified concepts by adjusting the general language model based on the one or more identified concepts. For example, one or more language models associated with the one or more identified concepts can be interpolated with the general language model to generate a language model that is adapted to the one or more concepts. In another implementation, probabilities associated with terms of a general language model can be adjusted based on the one or more identified concepts, for example, by increasing or decreasing probabilities associated with particular terms based on their relevance to the one or more identified concepts. In some instances, terms can be added or removed from a general language model based on the one or more identified concepts.

The voice recognition system 210 can obtain a transcription of the voice input 203 by performing voice recognition on the voice data 212 associated with the voice input 203. For example, the voice recognition system 210 can obtain a transcription of a voice input 203 using one or more concept-specific language models or using a general language model that has been adapted based on the one or more identified concepts. The transcription of the voice input 203 can be a textual representation of the voice input 203, for example, a textual representation of the voice input 203 that can be analyzed to determine a particular action that the computing device 204 is intended to perform, a textual representation that can be submitted as a query, for example, to a search engine, or can be any other textual representation intended for use by the computing device 204.

Based on obtaining the transcription of the voice input 203, the voice recognition system 210 can transmit the transcription, and the computing device 204 can receive the transcription from the voice recognition engine 210. In some implementations, the computing device 204 can receive the transcription using the communications channel 211 and can perform a function or determine a function to perform based on or using the transcription of the voice input 203. In some implementations the communications channel 211 can be one or more wired or wireless data channels, or one or more network data channels, such as one or more local area network (LAN) data channels or wide area network (WAN) data channels.

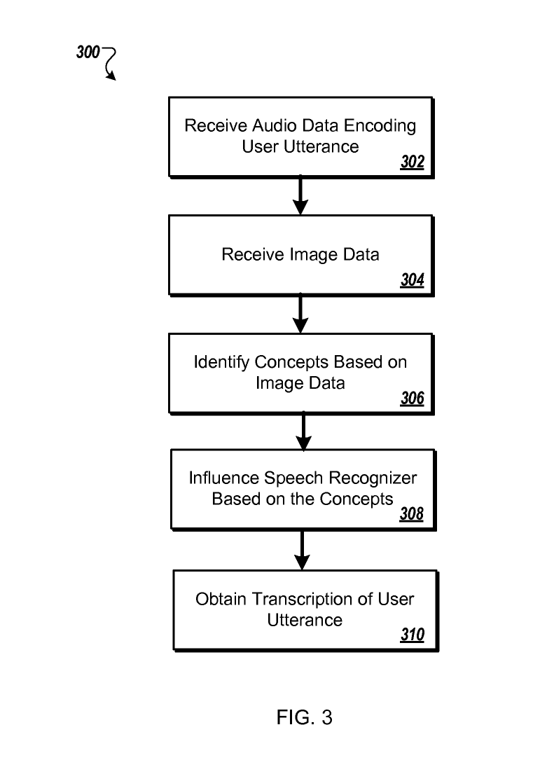

FIG. 3 is a flowchart of a method 300 for performing video analysis based language model adaptation. In general, the method 200 involves using data from the environment of the user to assist in the recognition of a spoken utterance obtained in audio data.

At step 302, audio data encoding a user utterance is received. For example, the computing device 204 of FIG. 2 can receive data encoding a voice input provided by a user 202 at an interface of the computing device 204. In some instances, the audio data encoding the user utterance can be data encoding a command provided by a user, data encoding an inquiry provided by a user, or can be audio data encoding voice inputs provided by a user of a computing device for another purpose.

At step 304, image data is received that is obtained from the environment of a user. For example, the computing device 204 of FIG. 2 can receive image data obtained from the environment of a user 202, where the image data can be obtained by a camera or video recorder associated with the user's computing device 204. In some instances, data can be received alternatively or in addition to the image data. For example, data received can include image and/or video data from the environment of a user, ambient audio data from the environment of a user, motion data from the environment of a user, geographical location data identifying a location of a user, temperature data obtained from the environment of a user, ambient light data obtained from the environment of a user, humidity data obtained from the environment of a user, and/or moisture data obtained from the environment of a user.

At step 306, one or more concepts can be identified based on the received image data. For example, based on the computing device 204 receiving image data that includes image features corresponding to a car or driving setting, one or more concepts associated with a car or driving setting can be identified. In some implementations, one or more concepts can be identified using the image data based on performing optical character recognition, feature matching, or shape matching on the received image data. In some implementations, one or more concepts can be identified based on analyzing data obtained alternatively or in addition to the received image data. For example, one or more concepts can be identified based on analyzing any of, or any combination of, image and/or video data, ambient audio data, motion data, geographical location data, temperature data, ambient light data, humidity data, moisture data, etc.

At step 308, a speech recognizer used to perform speech recognition is influenced based on the one or more identified concepts. In some instances, influencing a speech recognizer can include influencing a language model used in performing speech recognition on received audio data. For example, a language model associated with performing speech recognition can be created and/or adjusted based on the one or more identified concepts.

In some instances, based on the identified concepts, one or more concept-specific language models can be identified and can be associated with the speech recognizer used to perform speech recognition. In other instances, the one or more concept-specific language models can be interpolated and the resulting interpolated language model can be associated with the speech recognizer for use in performing speech recognition. In still other instances, a general language model can be associated with the speech recognizer, and the general language model can be adjusted based on the one or more identified concepts. For example, terms can be added and/or removed from the general language model based on the one or more identified concepts. In some instances, probabilities associated with terms of the general language model can be adjusted based on the one or more identified concepts, for example, by increasing and/or decreasing probabilities associated with the terms. In some instances, one or more concept-specific language models associated with the one or more identified concepts can be interpolated with the general language model, and the resulting interpolated general language model can be associated with the speech recognizer for use in performing speech recognition.

At step 310, a transcription of the user utterance can be obtained using the influenced speech recognizer and the received audio data encoding the user utterance. For example, the audio data encoding the user utterance can be accessed by the influenced speech recognizer, and the influenced speech recognizer can obtain a transcription of the user utterance by performing speech recognition on the audio data. In some instances, as a result of the speech recognizer being influenced based on the one or more identified concepts, the transcription of the user utterance can be more relevant to the one or more identified concepts. For example, as a result of the speech recognizer being influenced based on identified concepts that include a concept associated with a car or driving and a concept associated with a beach or ocean, the transcription of a user utterance can be tailored to match these concepts. For instance, a speech recognizer that has been influenced based on a concept associated with a car or driving and a concept associated with a beach or ocean may correctly transcribe a user utterance as containing the term “beach” in lieu of transcribing the same term in the user utterance as the term “beech.”

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

For instances in which the systems and/or methods discussed here may collect personal information about users, or may make use of personal information, the users may be provided with an opportunity to control whether programs or features collect personal information, e.g., information about a user's social network, social actions or activities, profession, preferences, or current location, or to control whether and/or how the system and/or methods can perform operations more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained, such as to a city, ZIP code, or state level, so that a particular location of a user cannot be determined. Thus, the user may have control over how information is collected about him or her and used.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both.

The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Thus, particular embodiments have been described. Other embodiments are within the scope of the following claims. For example, the actions recited in the claims may be performed in a different order and still achieve desirable results.

What is claimed is:

1. A computer-implemented method comprising:
receiving audio data obtained by a microphone of a wearable computing device, wherein the audio data encodes an utterance of a user;
receiving image data obtained by a camera of the wearable computing device;
identifying one or more image features based on the image data;
classifying the image data as pertaining to a particular activity, based at least on the one or more image features, wherein the particular activity is unrelated to providing an explicit user input to the wearable computing device;
selecting one or more terms associated with a language model used by a speech recognizer to generate transcriptions;
adjusting one or more probabilities associated with the language model that correspond to one or more of the selected terms based on the relevance of one or more of the selected terms to the particular activity; and
obtaining, as an output of the speech recognizer that uses the adjusted probabilities, a transcription of the user utterance.

2. The method of claim 1, wherein classifying the image data as pertaining to the activity comprises:
obtaining a result of performing at least an optical character recognition process on the image data; and
classifying the image data as pertaining to the particular activity based at least on the result.

3. The method of claim 1, wherein classifying the image data as pertaining to the particular activity comprises:
obtaining a result of performing a feature matching process on the image data; and
classifying the image data as pertaining to the particular activity based at least on the result.

4. The method of claim 1, wherein classifying the image data as pertaining to the particular activity comprises:
obtaining a result of performing a shape matching process on the image data; and
classifying the image data as pertaining to the particular activity based at least on the result.

5. A system comprising:
one or more computers and one or more storage devices storing instructions that are operable, when executed by the one or more computers, to cause the one or more computers to perform operations comprising:
receiving audio data encoding an utterance of a user;
receiving image data;
classifying the image data as pertaining to a particular activity, based at least on a result of analyzing the image data, wherein the particular activity is unrelated to providing an explicit user input to the one or more computers;
influencing a speech recognizer based at least on classifying the image data as pertaining to the particular activity; and
obtaining a transcription of the user utterance using the influenced speech recognizer.

6. The system of claim 5, wherein classifying the image data as pertaining to the particular activity comprises:
obtaining a result of performing at least an optical character recognition process on the image data; and
classifying the image data as pertaining to the particular activity based at least on the result.

7. The system of claim 5, wherein classifying the image data as pertaining to the particular activity comprises:
obtaining a result of performing a feature recognition process on the image data; and
classifying the image data as pertaining to the particular activity based at least on the result.

8. The system of claim 5, wherein classifying the image data as pertaining to the particular activity comprises:
obtaining a result of performing a shape matching process on the image data; and
classifying the image data as pertaining to the particular activity based at least on the result.

9. The system of claim 5, wherein influencing the speech recognizer based at least on classifying the image data as pertaining to the particular activity comprises:
selecting one or more terms associated with a language model; and
adjusting one or more probabilities associated with the language model that correspond to one or more of the selected terms based on the relevance of one or more of the selected terms to the particular activity, wherein the speech recognizer uses the language model comprising the adjusted probabilities to generate the transcription.

10. The system of claim 5, wherein influencing the speech recognizer based at least on classifying the image data as pertaining to the particular activity, comprises:
selecting a language model associated with the particular activity, wherein the speech recognizer uses the selected language model to generate the transcription.

11. The system of claim 5, wherein influencing the speech recognizer based at least on classifying the image data as pertaining to the particular activity comprises:
selecting a language model associated with the particular activity; and
interpolating the language model associated with the particular activity with a general language model, wherein the speech recognizer uses the interpolated language model to generate the transcription.

12. The system of claim 5, wherein:
the audio data encoding the utterance of the user is obtained by a microphone of a wearable computing device; and
the image data is obtained by a camera of the wearable computing device.

13. A computer readable storage device encoded with a computer program, the program comprising instructions that, if executed by one or more computers, cause the one or more computers to perform operations comprising:
receiving audio data encoding an utterance of a user;
receiving image data;
classifying the image data as pertaining to a particular activity, based at least on a result of analyzing the image data, wherein the particular activity is unrelated to providing an explicit user input to the one or more computers;
influencing a speech recognizer based at least on classifying the image data as pertaining to the particular activity; and
obtaining a transcription of the user utterance using the influenced speech recognizer.

14. The device of claim 13, wherein classifying the image data as pertaining to the particular activity comprises:
obtaining a result of performing at least an optical character recognition process on the image data; and
classifying the image data as pertaining to the particular activity based at least on the result.

15. The device of claim 13, wherein classifying the image data as pertaining to the particular activity comprises:
obtaining a result of performing a feature recognition process on the image data; and
classifying the image data as pertaining to the particular activity based at least on the result.

16. The device of claim 13, wherein classifying the image data as pertaining to the particular activity comprises:
obtaining a result of performing a shape matching process on the image data; and
classifying the image data as pertaining to the particular activity based at least on the result.

17. The device of claim 13, wherein influencing the speech recognizer based at least on classifying the image data as pertaining to the particular activity comprises:
selecting one or more terms associated with a language model; and
adjusting one or more probabilities associated with the language model that correspond to one or more of the selected terms based on the relevance of one or more of the selected terms to the particular activity, wherein the speech recognizer uses the language model comprising the adjusted probabilities to generate the transcription.

18. The device of claim 13, wherein influencing the speech recognizer based at least on classifying the image data as pertaining to the particular activity comprises:
selecting a language model associated with the particular activity, wherein the speech recognizer uses the selected language model to generate the transcription.

19. The device of claim 13, wherein influencing the speech recognizer based at least on classifying the image data as pertaining to the particular activity comprises:
selecting a language model associated with the particular activity; and
interpolating the language model associated with the particular activity with a general language model, wherein the speech recognizer uses the interpolated language model to generate the transcription.

20. The device of claim 13, wherein:
the audio data encoding the utterance of the user is obtained by a microphone of a wearable computing device; and
the image data is obtained by a camera of the wearable computing device.

21. The method of claim 1, wherein classifying the image data as pertaining to the particular activity comprises:
classifying the image data as pertaining to the particular activity without performing an optical character recognition process on the image data.

22. The system of claim 5, wherein classifying the image data as pertaining to the activity comprises:
identifying, without performing an optical character recognition process on the image data, one or more image features associated with the image data; and
classifying the image data as pertaining to the particular activity based at least on the one or more identified image features.

23. The device of claim 13, wherein classifying the image data as pertaining to the particular activity comprises:
identifying, without performing an optical character recognition process on the image data, one or more image features associated with the image data; and
classifying the image data as pertaining to the particular activity based at least on the one or more identified image features.

24. (canceled)

25. The method of claim 1, wherein the particular activity is one of driving, running, shopping, or attending a concert.
